(19) United States
(12) Patent Application Publication
(10) Pub. No.: US 2011/0026591 A1
(43) Pub. Date: Feb. 3, 2011

(54) SYSTEM AND METHOD OF COMPRESSING VIDEO CONTENT

(76) Inventors: Judit Martinez Bauza, San Diego, CA (US); Krishnan Rajamani, San Diego, CA (US); Samir Soliman, San Diego, CA (US)

Correspondence Address: QUALCOMM INCORPORATED, 5775 MOREHOUSE DR., SAN DIEGO, CA, 92121, US

(21) Appl. No.: 12/511,329

(22) Filed: Jul. 29, 2009

(51) Int. Cl. H04N 11/02

(52) U.S. Cl. 375/240.12; 375/240.01

(57) ABSTRACT

A method of compressing video content is disclosed and may include receiving an image frame of a video signal having multiple components, generating an edge-map for the image frame, generating a bitstream base layer for each component of the video signal, generating a first bitstream enhancement layer for each component of the video signal, and generating successive bitstream enhancement layers for each component of the video signal. As the successive bitstream enhancement layers are generated, the method of compressing video content goes from lossy to lossless.

### RELATED APPLICATIONS

The present application incorporates by reference in its entirety co-pending U.S. patent application Ser. No. ______, entitled SYSTEM AND METHOD OF COMPRESSING VIDEO CONTENT, filed on evendate herewith.

### SUMMARY

A method of compressing video content is disclosed and may include receiving an image frame of a video signal having multiple components, generating an edge-map for the image frame, generating a bitstream base layer for each component of the video signal, generating a first bitstream enhancement layer for each component of the video signal, and generating successive bitstream enhancement layers for each component of the video signal. As the successive bitstream enhancement layers are generated, the method of compressing video content goes from lossy to lossless.

In this aspect, the edge-map may be generated by locating all edges of an image within the current image frame. Additionally, the method may include determining a predicted edge pixel value, for each pixel in the current edge-map, using edge pixel values in the previous image frame that are in the neighborhood of the location of the current edge pixel. The method may include outputting the entropy encoded value of the difference between the predicted edge pixel value and the current edge pixel value. Additionally, the method may include outputting the entropy encoded value of the location of the current edge pixels. The location may be implicitly represented using a run-length formatting of the edge-map.

In this aspect, the method may also include scanning each row of pixels from the current image and determining each midpoint for each row of pixels. Further, the method may include scanning each column of pixels from the current image and determining each midpoint for each column of pixels. Each midpoint may be a midpoint between two edges, a midpoint between one edge and an image border, or a midpoint between two opposite image borders.

In this aspect, the method may include obtaining current pixel samples and the current pixel samples may include midpoint data for each row and midpoint data for each column. Moreover, the method may include scanning each row of sampled pixels, determining whether a distance between previously sampled pixels for each row of sample pixels is greater than a scalability factor, and determining a midpoint between previously sampled pixels for each row of sample pixels when the distance between previously sampled pixels is greater than the scalability factor.

The method may also include scanning each column of sampled pixels, determining whether a distance between previously sampled pixels for each column of sample pixels is greater than a scalability factor, and determining a midpoint between previously sampled pixels for each column of sample pixels when the distance between previously sampled pixels is greater than the scalability factor. Additionally, the method may include determining two nearest pixel samples from a previous iteration for each current pixel sample and determining whether the two nearest pixel samples are within the edges of the image. The method may also include setting a value of the predicted current pixel sample equal to a weighted average value of the two nearest pixel samples, when the two nearest pixel samples are within the edges of the image and setting a value of the predicted current pixel sample equal to a value of the closest pixel sample within the edges of the image, when the two nearest pixel samples are not within the edges of the image. The method may also include outputting the entropy encoded value of the difference between the predicted current pixel sample and the current pixel sample, for each pixel sample in the current image.

Additionally, the method may include reducing the scalability factor, and iterating the process.

In another aspect, a wireless device is disclosed. The wireless device may include means for receiving an image frame of a video signal having multiple components, means for generating an edge-map for the image frame, means for generating a bitstream base layer for each component of the video signal, means for generating a first bitstream enhancement layer for each component of the video signal, and means for generating successive bitstream enhancement layers for each component of the video signal. As the successive bitstream enhancement layers are generated, compressed video content goes from lossy to lossless.

In this aspect, the edge-map is generated by locating all edges of an image within the current image frame. Additionally, the wireless device may include means for determining a predicted edge pixel value, for each pixel in the current edge-map, using edge pixel values in the previous frame that are in the neighborhood of the location of the current edge pixel. The wireless device may include means for outputting the entropy encoded value of the difference between the predicted edge pixel value and the current edge pixel value. Also, the wireless device may include means for outputting the entropy encoded value of the location of the current edge pixels. The location may be implicitly represented using a run-length formatting of the edge-map.

Further, the wireless device may include means for scanning each row of pixels from the current image and means for determining each midpoint for each row of pixels. The wireless device may also included means for scanning each column of pixels from the current image and means for determining each midpoint for each column of pixels. Each midpoint may be a midpoint between two edges, a midpoint between one edge and an image border, or a midpoint between two opposite image borders.

In this aspect, the wireless device may also include means for obtaining current pixel samples, wherein the current pixel samples include midpoint data for each row and midpoint data for each column. Moreover, the wireless device may include means for scanning each row of sampled pixels, means for determining whether a distance between previously sampled pixels for each row of sample pixels is greater than a scalability factor, and means for determining a midpoint between previously sampled pixels for each row of sample pixels when the distance between previously sampled pixels is greater than the scalability factor.

The wireless device may further include means for scanning each column of sampled pixels, means for determining whether a distance between previously sampled pixels for each column of sample pixels is greater than a scalability factor, and means for determining a midpoint between previously sampled pixels for each column of sample pixels when the distance between previously sampled pixels is greater than the scalability factor. Also, the wireless device may include means for determining two nearest pixel samples from a previous iteration for each current pixel sample and means for determining whether the two nearest pixel samples are within the edges of the image. In this aspect, the wireless device may include means for setting a value of the predicted current pixel sample equal to a weighted average value of the two nearest pixel samples, when the two nearest pixel samples are within the edges of the image and means for setting a value of the predicted current pixel sample equal to a value of the closest pixel sample within the edges of the image, when the two nearest pixel samples are not within the edges of the image. The wireless device may also include means for outputting the entropy encoded value of the difference between the predicted current pixel sample and the current pixel sample, for each pixel in the current image. Also, the wireless device may include means for reducing the scalability factor and iterating the process.

In yet another aspect, a wireless device is disclosed. The wireless device may include a processor. The processor may be operable to receive an image frame of a video signal having multiple components, generate an edge-map for the image frame, generate a bitstream base layer for each component of the video signal, generate a first bitstream enhancement layer for each component of the video signal, and generate successive bitstream enhancement layers for each component of the video signal. As the successive bitstream enhancement layers are generated, compressed video content goes from lossy to lossless. The edge-map may be generated by locating all edges of an image within the current image frame.

The processor may be also be operable to determine a predicted edge pixel value, for each pixel in the current edge-map, using edge pixel values in the previous image frame that are in the neighborhood of the location of the current edge pixel. The processor may be operable to output the entropy encoded value of the difference between the predicted edge pixel value and the current edge pixel value. Also, the processor may be operable to output the entropy encoded value of the location of the current edge pixels. The location may be implicitly represented using a run-length formatting of the edge-map.

In this aspect, the processor may be further operable to scan each row of pixels from the current image and determine each midpoint for each row of pixels. Further, the processor may be operable to scan each column of pixels from the current image and determine each midpoint for each column of pixels. Each midpoint may be a midpoint between two edges, a midpoint between one edge and an image border, or a midpoint between two opposite image borders.

In this aspect, the processor may be further operable to obtain current pixel samples, wherein the current pixel samples include midpoint data for each row and midpoint data for each column. Additionally, the processor may be operable to scan each row of sampled pixels, determine whether a distance between previously sampled pixels for each row of sample pixels is greater than a scalability factor, and determine a midpoint between previously sampled pixels for each row of sample pixels when the distance between previously sampled pixels is greater than the scalability factor. Also, the processor may be operable to scan each column of sampled pixels, determine whether a distance between previously sampled pixels for each column of sample pixels is greater than a scalability factor, and determine a midpoint between previously sampled pixels for each column of sample pixels when the distance between previously sampled pixels is greater than the scalability factor.

Moreover, in this aspect, the processor may be operable to determine two nearest pixel samples from a previous iteration for each current pixel sample and determine whether the two nearest pixel samples are within the edges of the image. The processor may also be operable to set a value of the predicted current pixel sample equal to a weighted average value of the two nearest pixel samples, when the two nearest pixel samples are within the edges of the image and set a value of the predicted current pixel sample equal to a value of the closest pixel sample within the edges of the image, when the two nearest pixel samples are not within the edges of the image. Further, the processor may be operable to output the entropy encoded value of the difference between the predicted current pixel sample and the current pixel sample for each pixel sample in the current image. Additionally, the processor may be operable to reduce the scalability factor and iterate the process.

In still another aspect, a computer program product is disclosed and may include a computer-readable medium. The computer-readable medium may include at least one instruction for receiving an image frame of a video signal having multiple components, at least one instruction for generating an edge-map for the image frame, at least one instruction for generating a bitstream base layer for each component of the video signal, at least one instruction for generating a first bitstream enhancement layer for each component of the video signal, and at least one instruction for generating successive bitstream enhancement layers for each component of the video signal. As the successive bitstream enhancement layers are generated, compressed video content may go from lossy to lossless. The edge-map may be generated by locating all edges of an image within the current image frame.

Also, the computer-readable medium may include at least one instruction for determining a predicted edge pixel value, for each pixel in the current edge-map, using edge pixel values in the previous image frame that are in the neighborhood of the location of the current edge pixel. The computer-readable medium may include at least one instruction for outputting the entropy encoded value of the difference between the predicted edge pixel value and the current edge pixel value. Additionally, the computer-readable medium may include at least one instruction for outputting the entropy encoded value of the location of the current edge pixels. The location may be implicitly represented using a run-length formatting of the edge-map.

In this aspect, the computer-readable medium may also include at least one instruction for scanning each row of pixels from the current image and at least one instruction for determining each midpoint for each row of pixels. Further, the computer-readable medium may include at least one instruction for scanning each column of pixels from the current image and at least one instruction for determining each midpoint for each column of pixels. Each midpoint may be a midpoint between two edges, a midpoint between one edge and an image border, or a midpoint between two opposite image borders.

The computer-readable medium may also include at least one instruction for obtaining current pixel samples, wherein the current pixel samples include midpoint data for each row and midpoint data for each column. Also, the computer-readable medium may include at least one instruction for scanning each row of sampled pixels, at least one instruction for determining whether a distance between previously sampled pixels for each row of sample pixels is greater than a scalability factor, and at least one instruction for determining a midpoint between previously sampled pixels for each row of sample pixels when the distance between previously sampled pixels is greater than the scalability factor.

In this aspect, the computer-readable medium may further include at least one instruction for scanning each column of sampled pixels, at least one instruction for determining whether a distance between previously sampled pixels for each column of sample pixels is greater than a scalability factor, and at least one instruction for determining a midpoint between previously sampled pixels for each column of sample pixels when the distance between previously sampled pixels is greater than the scalability factor. The computer-readable medium may also include at least one instruction for determining two nearest pixel samples from a previous iteration for each current pixel sample and at least one instruction for determining whether the two nearest pixel samples are within the edges of the image. Moreover, the computer-readable medium may include at least one instruction for setting a value of the predicted current pixel sample equal to a weighted average value of the two nearest pixel samples, when the two nearest pixel samples are within the edges of the image and at least one instruction for setting a value of the predicted current pixel sample equal to a value of the closest pixel sample within the edges of the image, when the two nearest pixel samples are not within the edges of the image. The computer-readable medium may also include at least one instruction for outputting the entropy encoded value of the difference between the predicted current pixel sample and the current pixel sample for each pixel sample in the current image. Also, the computer-readable medium may include at least one instruction for reducing the scalability factor and iterating the process.

### DESCRIPTION OF THE RELATED ART

When an external display or projector is connected to a mobile device using a wireless link, the data has to be transferred through a wireless channel. If the capacity of the channel is not large enough to handle the data transfer, the source, i.e., raw video, may be compressed. The capacity may not be large enough due to technical constraints of the physical layer of the radio link, e.g., interference that prevents the channel from being used to fully capacity. The capacity may also not be large enough if the channel is shared among other devices. Or, the capacity may not be large enough if a portion of the channel bandwidth is reserved for error mitigation or correction. Current compression methods have various limitations.

Therefore, what is needed is an improved system and method for compressing video content.

### BRIEF DESCRIPTION OF THE DRAWINGS

In the figures, like reference numerals refer to like parts throughout the various views unless otherwise indicated.

FIG. 1 is a diagram of a wireless system;

FIG. 2 is a diagram of a telephone;

FIG. 3 is a flowchart illustrating a method of compressing graphic content and video content for transmission via a wireless link is shown;

FIG. 4 is a flowchart illustrating a first portion of a scalable edge-preserving filtering and sub-sampling method;

FIG. 5 is a flowchart illustrating a second portion of the scalable edge-preserving filtering and sub-sampling method;

FIG. 6 is a first diagram of a pixel array;

FIG. 7 is a first diagram of a pixel array; and

FIG. 8 is a flowchart illustrating a linear prediction method.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, an “content” referred to herein, may also include files that are not executable in nature, such as documents that may need to be opened or other data files that need to be accessed.

In this description, the terms “communication device,” “wireless device,” “wireless telephone,” “wireless communications device,” and “wireless handset” are used interchangeably. With the advent of third generation (3G) wireless technology, more bandwidth availability has enabled more electronic devices with wireless capabilities. Therefore, a wireless device could be a cellular telephone, a pager, a PDA, a smartphone, a navigation device, or a computer with a wireless connection.

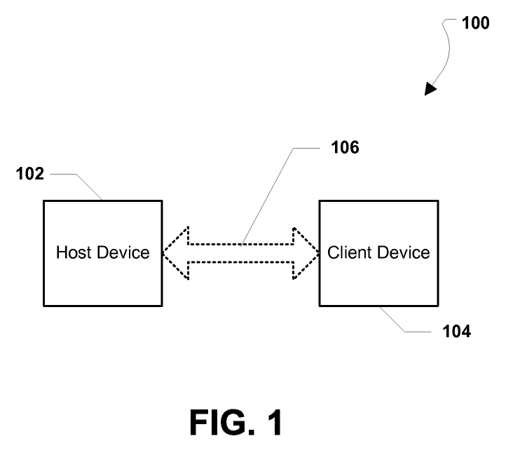

Referring initially to FIG. 1, a wireless mobile digital display interface (WMDDI) system is shown and is generally designated 100. As shown, the WMDDI system 100 includes a host device 102 and a client device 104. The host device 102 and the client device 104 may be connected via a wireless link 106. In a particular aspect, the host device may be a mobile device such as a cellular phone, a mobile phone, a portable data assistant (PDA), or some other handheld wireless device. Further, the client device 104 may be a wireless display having embedded capabilities such as audio/video decoding, HID, or a combination thereof. For example, the client device 104 may be an external display, a projector, or some other similar device. The wireless link 106 may a WMDDI.

In a particular aspect, the host device 102 and the client device 104 may be able to establish association and secure communication for the exchange of multimedia content and control messages using the WMDDI protocol. In one aspect, the communication may be asymmetric in the sense that a larger amount of data may be exchanged in the forward link, i.e., from the host device 102 to the client device 104.

In a particular aspect, the host device 102 may include several applications that may provide multimedia content. For example, the host device 102 may include a media player that may decode compressed video and audio bitstreams from a file. The host device 102 may also include one or more video games that may process graphic commands to render image content. Further, the host device 102 may include a camera, e.g., a charged coupled device (CCD) camera, a complementary metal oxide semiconductor (CMOS) camera, or some other camera, that may be used to stream captured red/green/blue (RGB) images. Each of these applications, and other applications that generate image content, may provide raw video, e.g., RGB or Cr/Cb/Y, to an internal display on the host device 102 with a resolution and a bit-depth that matches the resolution and bit-depth of the internal display. The internal display may be a liquid crystal display (LCD) or some other display. The bit rates for raw video content, e.g., RGB, at common display resolutions and frame rates are shown below in Table 1.

TABLE 1
RGB Bit Rates for Common Display Resolutions and Frame Rates.

| Video Sequence (24 bpp) | Bit Rate |
|---|---|
| QVGA (320 × 240), 30 fps | 55.3 Mbps |
| VGA (640 × 480), 30 fps | 221.2 Mbps |
| WVGA (864 × 480), 30 fps | 298.6 Mbps |
| HDTV (1080 × 1920, 30 fps | 1.5 Gbps |

When the client device 104 is connected to the host device 102 using the wireless link 106, the data transferred from the host device 102 to the client device 104 may be transferred through a wireless channel. If the capacity of the wireless channel is not large enough, the raw video data may be compressed. The capacity of the wireless channel may not be sufficient due to technical constraints of the physical layer of the wireless channel, due to the wireless channel being shared among other devices, due to some margin of the channel being retained for error mitigation techniques or correction techniques, or a combination thereof

The wireless link 106 may not provide a fixed capacity. Accordingly, video transmission through the wireless link 106 may be adaptable to varying channel conditions.

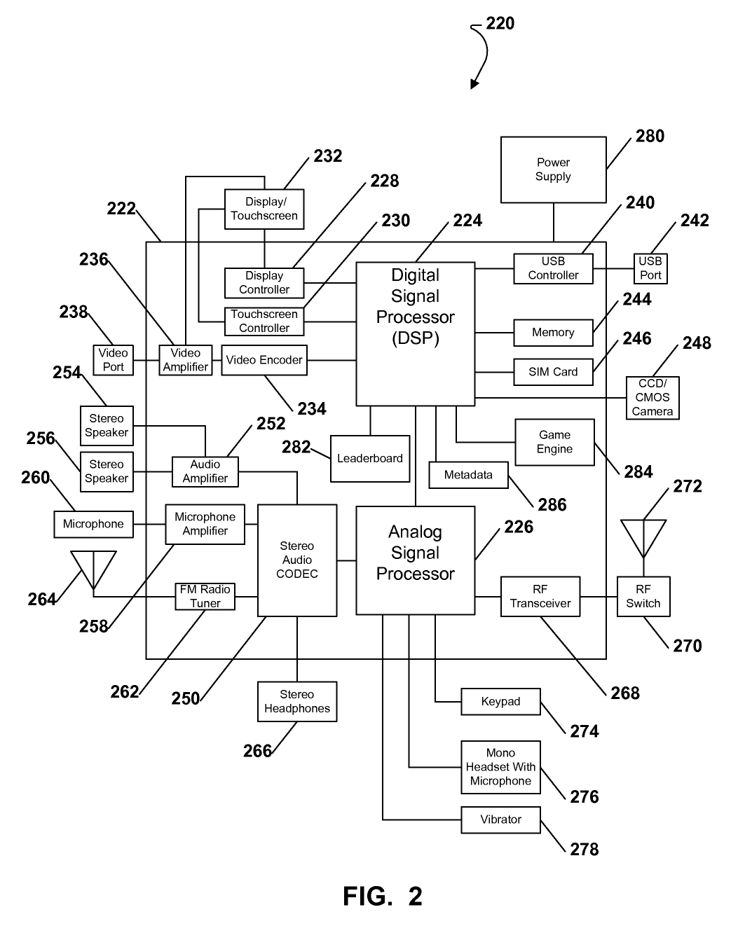

Referring to FIG. 2, an exemplary, non-limiting aspect of a wireless telephone is shown and is generally designated 220. As shown, the wireless device 220 includes an on-chip system 222 that includes a digital signal processor 224 and an analog signal processor 226 that are coupled together. As illustrated in FIG. 2, a display controller 228 and a touchscreen controller 230 are coupled to the digital signal processor 224. In turn, a touchscreen display 232 external to the on-chip system 222 is coupled to the display controller 228 and the touchscreen controller 230.

FIG. 2 further indicates that a video encoder 234, e.g., a phase alternating line (PAL) encoder, a sequential couleur a memoire (SECAM) encoder, or a national television system(s) committee (NTSC) encoder, is coupled to the digital signal processor 224. Further, a video amplifier 236 is coupled to the video encoder 234 and the touchscreen display 232. Also, a video port 238 is coupled to the video amplifier 236. As depicted in FIG. 2, a universal serial bus (USB) controller 240 is coupled to the digital signal processor 224. Also, a USB port 242 is coupled to the USB controller 240. A memory 244 and a subscriber identity module (SIM) card 246 may also be coupled to the digital signal processor 224. Further, as shown in FIG. 2, a digital camera 248 may be coupled to the digital signal processor 224. In an exemplary aspect, the digital camera 248 is a charge-coupled device (CCD) camera or a complementary metal-oxide semiconductor (CMOS) camera.

As further illustrated in FIG. 2, a stereo audio CODEC 250 may be coupled to the analog signal processor 226. Moreover, an audio amplifier 252 may coupled to the stereo audio CODEC 250. In an exemplary aspect, a first stereo speaker 254 and a second stereo speaker 256 are coupled to the audio amplifier 252. FIG. 2 shows that a microphone amplifier 258 may be also coupled to the stereo audio CODEC 250. Additionally, a microphone 260 may be coupled to the microphone amplifier 258. In a particular aspect, a frequency modulation (FM) radio tuner 262 may be coupled to the stereo audio CODEC 250. Also, an FM antenna 264 is coupled to the FM radio tuner 262. Further, stereo headphones 266 may be coupled to the stereo audio CODEC 250.

FIG. 2 further indicates that a radio frequency (RF) transceiver 268 may be coupled to the analog signal processor 226. An RF switch 270 may be coupled to the RF transceiver 268 and an RF antenna 272. As shown in FIG. 2, a keypad 274 may be coupled to the analog signal processor 226. Also, a mono headset with a microphone 276 may be coupled to the analog signal processor 226. Further, a vibrator device 278 may be coupled to the analog signal processor 226. FIG. 2 also shows that a power supply 280 may be coupled to the on-chip system 222. In a particular aspect, the power supply 280 is a direct current (DC) power supply that provides power to the various components of the wireless device 220 that require power. Further, in a particular aspect, the power supply is a rechargeable DC battery or a DC power supply that is derived from an alternating current (AC) to DC transformer that is connected to an AC power source.

As depicted in FIG. 2, the touchscreen display 232, the video port 238, the USB port 242, the camera 248, the first stereo speaker 254, the second stereo speaker 256, the microphone 260, the FM antenna 264, the stereo headphones 266, the RF switch 270, the RF antenna 272, the keypad 274, the mono headset 276, the vibrator 278, and the power supply 280 are external to the on-chip system 222.

In a particular aspect, one or more of the method steps described herein may be stored in the memory 244 as computer program instructions. These instructions may be executed by a processor 224, 226 in order to perform the methods described herein. Further, the processors, 224, 226, the memory 244, the instructions stored therein, or a combination thereof may serve as a means for performing one or more of the method steps described herein.

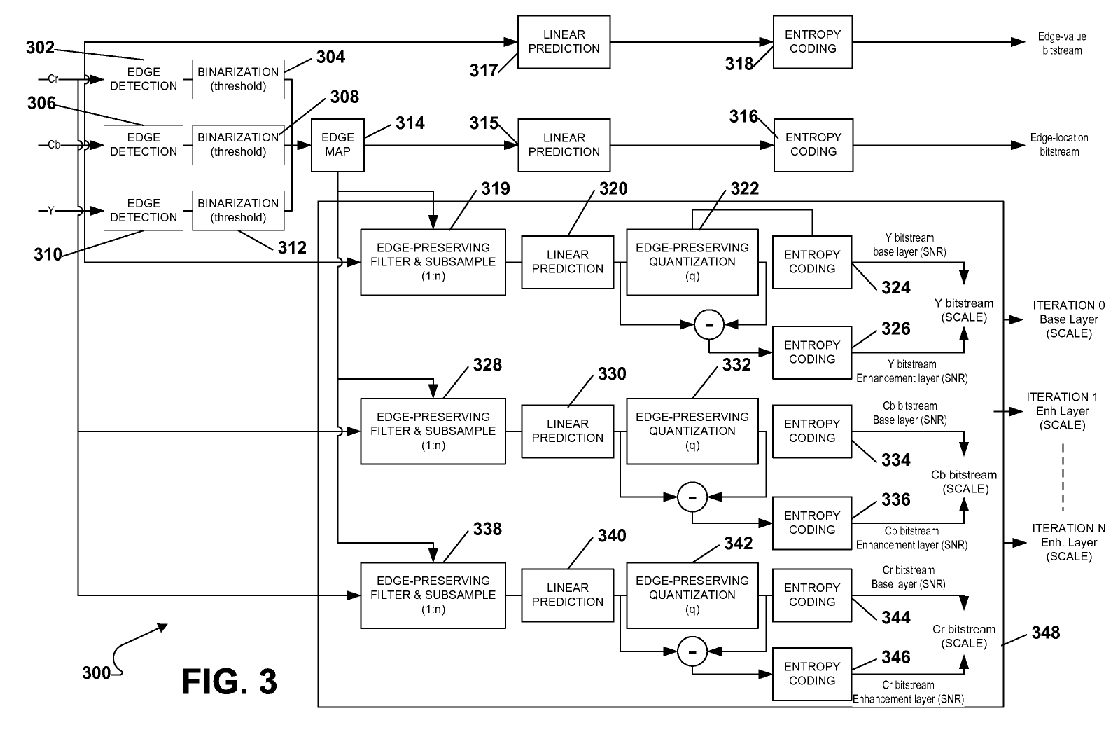

Referring now to FIG. 3, a method of compressing graphic content and video content for transmission via a wireless link is shown and is generally designated 300. In general, the method includes two pre-processing steps: edges detection and edge-preserving image sub-sampling. These steps may be followed by two separate encoding steps: edges-map encoding and texture-image encoding. A decoder may use the edge-map information in the decoding process. In a particular aspect, the input to the system may be the three components of a graphics or video signal, e.g., Cr/Cb/Y, R/G/B, etc. Each image component may be processed separately for edge detection and may use a different threshold. In such a case, the resulting binary images may be combined in a single edges-map image. An edge detector may use all three components at a time to decide the existence of edges. Alternatively, an edge detector may build an edges-map based on the information from a single component. In another alternative, an edge detector may build a separate edge-map for each component or a group of components. It may be appreciated that the edges in one component may not necessarily map to the edges in the other components. For example, the luminance of two different colors may be the same. However, in such a case, the transition between neighboring pixels with these colors may not show and edge in the luma component (Y).

Returning to the description of the method, beginning at block 302, edge detection may be performed for the first component of the signal. At block 304, a binarization process may be performed for the first component of the signal. Moreover, at block 306, edge detection may be performed for the second component of the signal. At block 308, the binarization process may be performed for the second component of the signal. Thereafter, edge detection may be performed for the third component of the signal at block 310. At block 312, the binarization process may be performed for the third component of the signal.

In a particular aspect, the binarization process performed on each component may include a threshold parameter that allows for adaption to local variations and provide an adjustable average setting. The average setting may be used to adjust the sensitivity of the binarization process with respect to detected edges. The average setting is related to the minimum required intensity variation between neighboring pixels that triggers the existence of an edge. The average setting may be used to adapt the encoding process to varying channel conditions. For example, the larger the value of the average setting, the less number of edges will be detected. Local adjustment may be used to account for non-uniform illumination of an image or frame. Alternatively, an image may be pre-processed to correct for non-uniform illumination previous to entering the edge detection process. Another alternative may pre-process the image to classify regions based on content and adapt the edge detector and binarization process to different regions according to content information. For example, a pre-process may classify regions as regions-with-text or regions-without-text.

Returning to the description of the method, a block 314, an edge-map may be generated, or otherwise created, based on the previous six steps, i.e., the edge detection and the binarization process performed on each component of the signal. In a particular aspect, the edge-map may be a binary-image in which each pixel is set to a “1” or a “0”. A value of “1” for a particular pixel indicates that the particular pixel includes edge data—based on the combination of the binarized images from the different components. A value of “0” for a particular pixel indicates that the pixel does not include edge data. Alternatively, the edge-map may be a label-image. In such a case, the value of each pixel may be set to “1”, “2”, or “3” to indicate whether a particular pixel is an edge of a corresponding component “1”, “2”, or “3”. Again, a value of “0” for any pixel indicates that the pixel does not include edge data. It may be appreciated that this concept may be applied to images having greater components, e.g., spectroscopic images or other multi-dimensional images.

At block 315, linear prediction may be applied to the locations of edges in the edge-map 314. Further, at block 316, entropy coding may be applied to the linear prediction of the locations of edges in the edge-map 314 and an edges-location bitstream may be output to a decoder. At block 317, linear prediction may be applied to the values of edges in the edge-map 314. Moreover, at block 318, entropy coding may be applied to the linear prediction of the value of edges in the edge-map 314 and the edges-value bitstream may be output to a decoder.

At block 319, a scalable edge-preserving filtering and sub-sampling method may be performed in the first component of the signal. At block 320, linear prediction may be performed on the first component of the signal. Further, at block 322, edge-preserving quantization may be performed on the first component of the signal. Thereafter, at block 324, a base layer created during steps 318 through 322 may be coded, e.g., using entropy coding. The encoded base layer may be output to a decoder. As shown, and described in detail herein, an enhancement layer may also be created during steps 318 through 322. At block 326, the enhancement layer may be coded, e.g., using entropy encoding. The encoded enhancement layer may also be output to a decoder.

Proceeding to block 328, the scalable edge-preserving filtering and sub-sampling method may be performed in the second component of the signal. At block 330, linear prediction may be performed on the second component of the signal. Further, at block 332, edge-preserving quantization may be performed on the second component of the signal. Thereafter, at block 334, a base layer created during steps 328 through 332 may be coded, e.g., using entropy coding. The encoded base layer may be output to a decoder. As shown, and described in detail herein, an enhancement layer may also be created during steps 328 through 332. At block 336, the enhancement layer may be coded, e.g., using entropy encoding. The encoded enhancement layer may also be output to a decoder.

At block 338, the scalable edge-preserving filtering and sub-sampling method may be performed in the third component of the signal. At block 340, linear prediction may be performed on the third component of the signal. Further, at block 342, edge-preserving quantization may be performed on the third component of the signal. Thereafter, at block 344, a base layer created during steps 338 through 342 may be coded, e.g., using entropy coding. The encoded base layer may be output to a decoder. As shown, and described in detail herein, an enhancement layer may also be created during steps 338 through 342. At block 346, the enhancement layer may be coded, e.g., using entropy encoding. The encoded enhancement layer may also be output to a decoder. One or more of the processes in block 348 may be repeated for several iterations. Successive iterations may use a reduced scale factor in the blocks 319, 328 and 338.

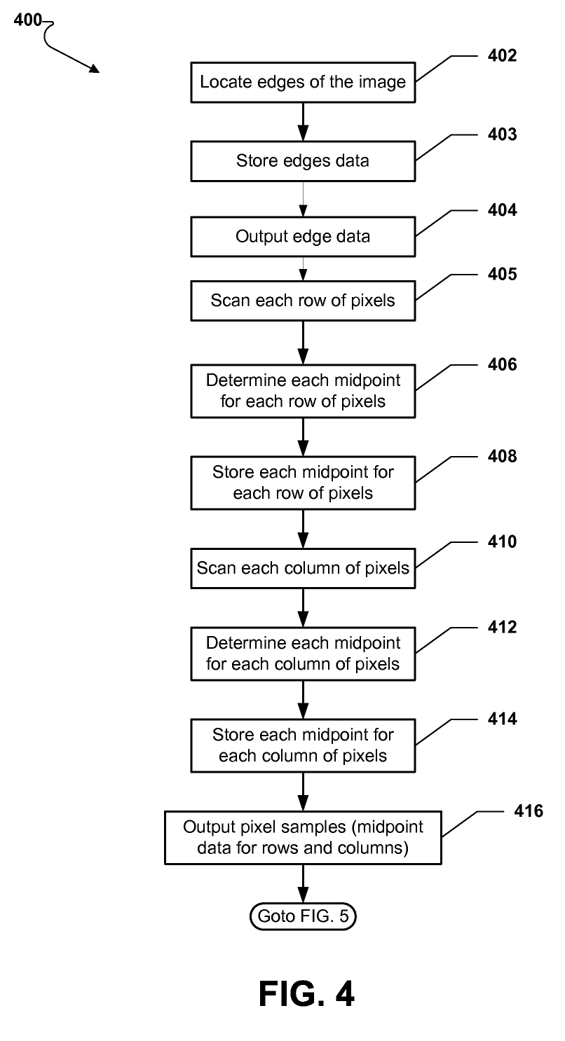

In a particular aspect, the scalable edge-preserving filtering and sub-sampling method performed on each component may be used to reduce image resolution. It may be appreciated that in terms of image content, the high frequency contribution is due to edge-transitions and noise. In this aspect, after the edges are detected, the pixels within the edge boundaries may contain nearly constant values—except for noise, e.g. Gaussian noise. Further, in this aspect, and described in detail below in conjunction with FIG. 4, the edge-preserving filtering and sub-sampling method may select a certain number of samples within the edge limits. The number of samples may depend on the scaling factor. The location of the samples may depend on the edge-map and the sub-sampling method. If the compression is lossless, the value of the sample may match that of the pixel at the sample location. If the compression is lossy, the value of the sample may be a function of the pixels within the edge boundaries, e.g., an average value or a median value.

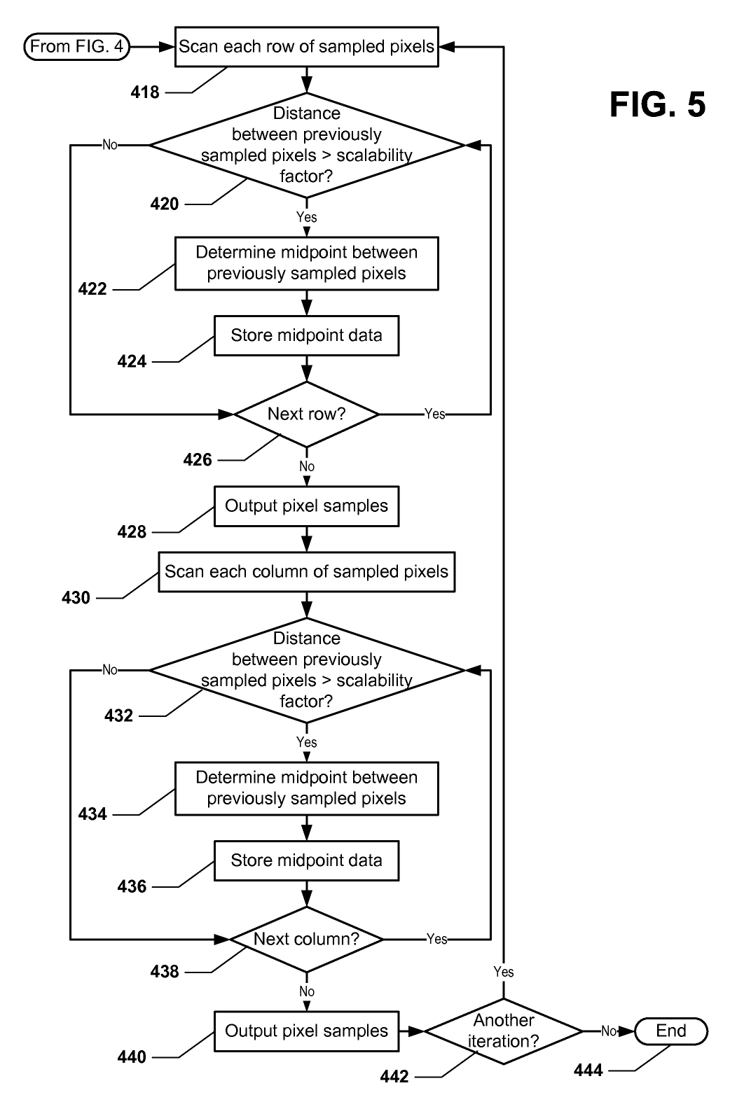

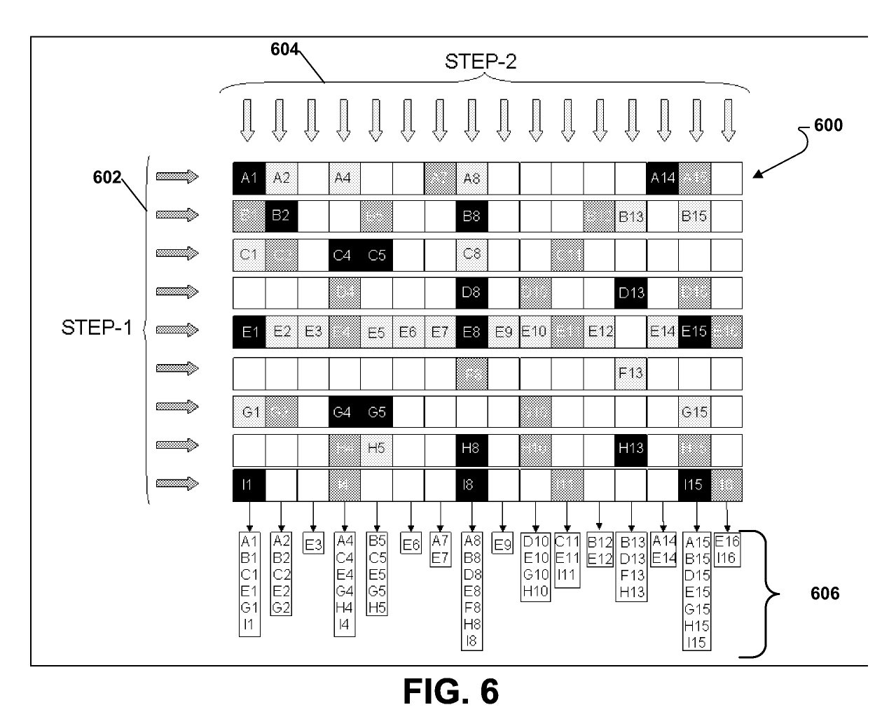

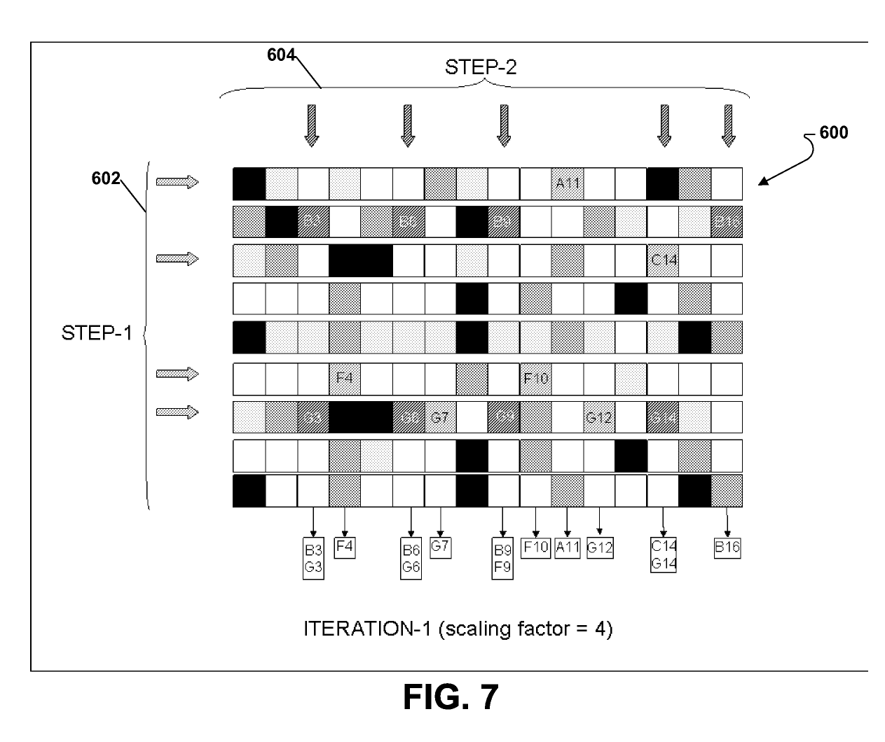

Referring to FIG. 4 and FIG. 5, a scalable edge-preserving filtering and sub-sampling method is shown and is designated 400. The scalable edge-preserving filtering and sub-sampling method may be performed for at least two iterations. FIG. 6 is a representation of a first iteration of the method as applied to a pixel array 600 and FIG. 7 is a representation of a second, or subsequent, iteration of the method as applied to the pixel array 600. As shown in FIG. 6 and FIG. 7, the pixel array 600 includes a plurality of rows 602 that may be lettered A through I. The pixel array 600 may also include a plurality of columns 604 that may be numbered one (1) through sixteen (16).

In the first iteration, i.e., the lowest resolution iteration, the output of the method will provide the value of the pixels located at the edges according to the edge-map and the midpoint between the edges. The midpoint is chosen for each row of pixels, i.e., in the X direction, by scanning in the horizontal direction and for each column of pixels, i.e., in the Y direction by scanning in the vertical direction. The midpoint may be between two edges, between one edge and the border of the image, or between the two opposite borders of the image.

In the succeeding iteration, or iterations, the remaining pixels may be sub-sampled according to the same separable rule, i.e., horizontally and vertically. However, the midpoint may be selected between pixels sampled during any previous iteration if the distance between the sampled pixels is greater than a scalability factor defined for the present iteration. It may be appreciated that the method shown in FIG. 4 does not generate the same number of samples per row or the same number of samples per column. The number of samples and the locations of those samples may depend on the edge-map and the previous sample iterations.

Returning to the description of the method, beginning at block 402, the edges of the image may be located. For example, as shown in FIG. 6, the edge pixels may include A1, A14, B2, B8, C4, C5, D8, D13, E1, E8, E15, G4, G5, H8, H13, I1, I8, and I15. At block 403, the edge data may be stored. At block 404 the edge data may be output. At block 405, each row of pixels comprising the image may be scanned. At block 406, each midpoint for each row of pixels may be determined. As shown in FIG. 6, the midpoint pixels for the rows 602 may include A7, A15, B1, B5, B12, C2, C11, D4, D10, D15, E4, E11, E16, F8, G2, G10, H4, H10, H15, I4, I11, and I16. Moving to block 408, each midpoint for each row of pixels may be stored.

Proceeding to block 410, each column of pixels may be scanned. At block 412, each midpoint for each column of pixels may be determined. Further, at block 414, each midpoint for each column of pixels may be determined. For example, as shown in FIG. 6, the midpoint pixels associated with the columns 604 may include A2, A4, A8, B13, B15, C1, C8, E2, E3, E5, E6, E7, E9, E10, E12, E14, F13, G1, G15, and H5. At block 416, pixel samples may be output. The pixel samples may include the midpoint data associated with the rows and columns of pixels. Further, the pixel samples may include the edge data associated with the rows and columns of pixels. In FIG. 6, the output is generally designated 606. From block 416, the method may proceed to block 418 of FIG. 5.

At block 418, each row of sampled pixels may be scanned. Moving to decision step 420, it may be determined whether a distance between previously sampled pixels is greater than a scalability factor. If so, the method may proceed to block 422 and a midpoint between previously sampled pixels may be determined. At block 424, the midpoint data may be stored. The method may then continue to decision step 426. Returning to decision step 420, if the distance between previously sampled pixels is not greater than a scalability factor, the method may proceed directly to decision step 426.

At decision step 426, it may be determined whether the data includes another row of previously sampled pixels. If so, the method may return to decision step 420 and continue as described herein. If not, the method may continue to block 428 and the pixels samples may be output. Referring to FIG. 7, the pixel samples include A11, C14, F4, F10, G7, and G12.

Proceeding to block 430, each column of sampled pixels may be scanned. Moving to decision step 432, it may be determined whether a distance between previously sampled pixels is greater than a scalability factor. If so, the method may proceed to block 434 and a midpoint between previously sampled pixels may be determined. At block 436, the midpoint data may be stored. The method may then continue to decision step 438. Returning to decision step 432, if the distance between previously sampled pixels is not greater than a scalability factor, the method may proceed directly to decision step 438.

At decision step 438, it may be determined whether the data includes another column of previously sampled pixels. If so, the method may return to decision step 432 and continue as described herein. If not, the method may continue to block 440 and the pixels samples may be output. Referring to FIG. 7, the pixel samples include B3, B6, B9, B16, G3, G6, G9, and G14. Moving to decision step 442, it may be determined whether to perform another iteration. If another iteration is performed, the method may return to block 418 and continue as described herein. If not, the method may end at state 444.

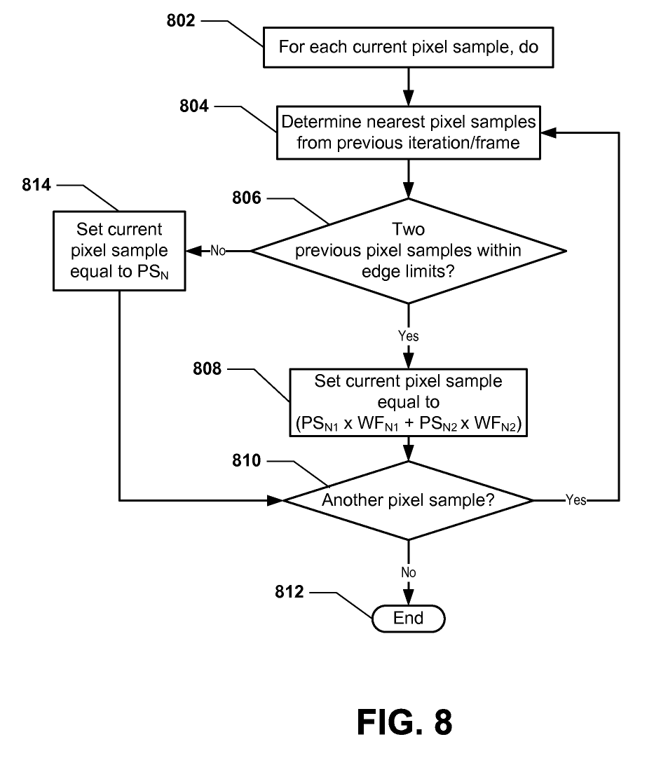

Referring now to FIG. 8, a method of linear prediction of midpoint samples is shown and is generally designated 800. In a particular aspect, the linear prediction method may predict the value of pixels in a current iteration from the values of the pixels in an immediately previous iteration. For the initial iteration, the prediction method may predict the values from the value of the pixels in the previous frame. In a particular aspect, to obtain predicted values, the values of the edge pixels may not be considered. The linear prediction method may use the weighted average of the two nearest sampled pixels from the previous iteration. The two nearest sampled pixels include one pixel before the current pixel and one pixel after the current pixel when the row, or column, of pixels is scanned in a particular direction. In a particular aspect, the two nearest pixels may be within the edge limits. In the case that there is only one sample pixel from the previous iteration that is within the edge limits and in the same scanning direction, the value of that particular pixel may be used as the prediction value. It may be appreciated that the entropy of the prediction error may be smaller than the entropy of the sampled values and may be more efficiently coded using entropy-coding since the pixels within the edge boundaries may contain similar values.

Returning to the description of the linear prediction method, commencing at block 802, for each current pixel sample, the following steps are performed. At block 804, the nearest pixels samples from the previous iteration are determined. Moving to decision step 806, it is determined whether the two nearest pixel samples from the previous iteration are within the edge limits. If so, the method may continue to block 808 and the current pixel sample may be set equal to the value first nearest pixel sample, PSN1, multiplied by a first weighting factor, WF_{N1}, plus the value second nearest pixel sample, PSN2, multiplied by a second weighting factor, WF_{N2}. The weighting factors may be a function of the distance from the current value to the nearest pixel samples, for example: WF_{N1}=d_{N2}/(d_{N1}+d_{N2}) and WF_{N2}=d_{N1}/(d_{N1}+d_{N2}), where d_{N1} refers to the distance from the current pixel sample to one of the nearest pixel samples N1, and d_{N2} refers to the distance from the current pixel sample to the other nearest pixel samples N2.

Thereafter, the method may continue to decision step 810 and it may be determined if there is another pixel sample. If so, the method may return to block 804 and continue as described herein. Otherwise, if there is not another pixel sample, the method may end at state 812.

Returning to decision step 806, if the two nearest pixels samples from the previous iteration are not within the edge limits, the method may move to block 814. At block 814, the current pixel sample may be set equal to the value of the nearest pixel sample, PSN. Thereafter, the method may continue to decision step 810 and continue as described herein.

The results of the prediction in the first iteration are as follows:
The predicted value for A11 (horizontal scanning)=A7
The predicted value for C14 (horizontal scanning)=C11
The predicted value for F4 (horizontal scanning)=F8
The predicted value for F10 (horizontal scanning)=F8
The predicted value for G7 (horizontal scanning)=G10
The predicted value for G12 (horizontal scanning)=G10
The predicted value for B3 (vertical scanning)=E3
The predicted value for G3 (vertical scanning)=E3
The predicted value for B6 (vertical scanning)=E6
The predicted value for G6 (vertical scanning)=E6
The predicted value for B9 (vertical scanning)=E9
The predicted value for G9 (vertical scanning)=E9
The predicted value for G14 (vertical scanning)=E14
The predicted value for B16 (vertical scanning)=E16

In a particular aspect, the location of the edges in the edge-map discussed herein may be encoded using a run-length followed by entropy encoding. The run-length is a distance between consecutive “1” in the row of a binary image. For encoding the prediction error values, the encoding process may use entropy coding to efficiently encode the sampled. The encoding process may be made scalable with respect to SNR. In this aspect, the values may be quantized before entering the entropy encoder. The SNR-iteration-0 may provide a gross approximation to the sampled values. In subsequent SNR iterations, i.e., SNR-iterations-j (where j>0), these values may be refined. In other words, in subsequent SNR iterations, the granularity may be refined. This SNR scalability may be included in the process in addition to the scalability provided by subsequent iterations of the scalability factor in the sub-sampling process.

A simplification of the quantization process is bit-plane coding. For example, in a 2-layer approach, the SNR-iteration-0 may take 8 bits per Y component and only 4 per chroma component. In the SNR-iteration-1, the remaining bits for the chroma component may be taken. In this example, the initial range of values is constrained to 8 bits.

In a particular aspect, a receiver may utilize an entropy decoder for the edge-map bitstream and the texture-image bitstream. The decoder may be match to the encoding process. The receiver may also account for the sub-sampling process to locate received values and the knowledge of the edge-location. In other words, the receiver may embed the knowledge of the sub-sampling process used at the sender side.

With the configuration described herein, the system and method disclosed here is able to adapt to variable channel bit rate. The encoding process takes place in real-time, i.e., during transmission, and a feedback message about channel conditions is provided. As such, adjustment to the channel conditions may be achieved. Further, the system and method may be implemented in mobile devices, e.g., mobile telephones, having reduced processing capabilities due to both limited software and hardware resources. Also, the system and method may provide substantially lower power consumption during operation than other compression systems and methods.

Additionally, the system and method described herein provides good image quality for most common applications. The range of applications in which the compression method described herein may be utilized includes video requirements that may be quite different. For example, a business presentation may include content such as graphics, text, plots, and images. For such an application, the frame-rate may be quite low, e.g., less than one frame per second (1 fps). Also, a business presentation is not very sensitive to delay and any jitter in the signal is substantially unnoticeable. Further, since many business presentations include graphic generated images, many regions in two successive images remain substantially similar and partial updates may be provided. The typical display media for a business presentation is a projector and a user may expect that the text of the presentation is in focus, the edges of the images are well defined, and that fine details are easily discernable.

Another application includes video clips. Such content includes textured scenes that may have originated from camera acquisition or animated graphics, e.g., cartoons. The frame-rate for video content may be a minimum of twenty-four frames per second (24 fps) and typically is thirty frames per second (30 fps). However, for HDTV displays, the display rate may be sixty frames per second (60 fps) or higher. For video content, initial delay may be acceptable. However, jitter is very noticeable. Partial updates may be utilized for animated graphics in which many regions in two successive images remains substantially similar. For textured scenes, partial updates are unlikely to be utilized. Typically, video content may be viewed on a display, e.g., a liquid crystal display (LCD). However, a video clip may be provided as part of a presentation and may be viewed via a projector. With video content, viewers may be more sensitive to artifacts in animated graphics due to the sharper edges. Artifacts may be more tolerable in textured scenes.

The system and method described herein may also be utilized with web browsing content. Such content may include graphics, text, plots, images, and video clips. The frame-rate, delay, and jitter depend on the browser, the content viewed, the service provider, the connection speed, and other factors. Since many web pages are include graphic generated images, many regions in two successive images remain substantially similar and partial updates may be utilized. Typically, such content is displayed via an LCD display or a projector and a user may expect that the text of the presentation is in focus, the edges of the images are well defined, and that fine details are easily discernable. Also, for video a user may expect twenty-four to thirty frames per second (24-30 fps).

Still another application includes video conferencing. Such content typically includes the face of a person, particularly the lips and eyes of the person speaking. The background of such content may be flat or textured. The frame rate for video conferencing may be fifteen frames per second (15 fps), thirty frames per second (30 fps), or higher. Initial delay in video conferencing should be minimized and jitter in such content is quite noticeable. Partial updates may be utilized for the background and even if there are slight variations in the background, the background may be considered unchanged. The foreground, e.g., the face content, changes substantially with each new frame. The display typically used for such content is an LCD display, a projector, or a combination of both. A user may be sensitive to artifacts in the foreground and less sensitive to artifacts in the background.

In a particular aspect, the present system and method may preserve edges and text for applications having content that is based on graphics and text. Further, the system and method may provide lossless compression for such content. Alternatively, this content may be transmitted uncompressed for low frame rate updates, e.g., presentations. Textured content may transmitted lossy as it may tolerate lower accuracy. The system and method disclosed herein provides a relatively simple compression scheme that is well suited for both graphics based content and video content. Further, the system and method is adaptable to variable channel bandwidth that provides some resilience capabilities.

In a particular aspect, the system and method described herein provides a codec scheme that preserves edge data and is adaptable to varying channel capacity by adjusting resolution, signal-to-noise ratio (SNR) quality, or a combination thereof. The system and method described herein does not utilize a transform-based encoding/decoding scheme and according, this system and method avoids the Gibbs effect that is well known in the art. Further, the system and method preserves edge data during sub-sampling and encoding and may be used to compress the different types of content described herein. The sub-sampling process described herein adapts to the image content and it is non-uniform. Moreover, the compression of the system and method described herein may be lossy or lossless depending on the bandwidth of the transmission channel and the video frame rate. For example, if the frame rate is relatively slow the compression may be lossless.

In a particular aspect, the system and method described herein may use a scalable method to encode the image content that focuses on preserving the edge content. The system and method may avoid the Gibbs effect, e.g., ringing or mosquito noise, which is particularly useful for text and graphic content. The edge content preservation may be achieved by detecting the edges and prioritizing the encoding of this information using a lossless approach. The Gibbs effect may be avoided by not using a transform-based approach to de-correlate the image content. Conversely, as described herein, a non-uniform scalable sub-sampling method that takes into the account the edge information may be used. The system and method described herein may scale from lossy to lossless, depending on bandwidth capacity and frame-rate and may include adjustable parameters that may be used to select the sub-sampling factor or the SNR quality of the samples. The encoded information at different levels of scalability may be prioritized and unequal error protection strategies may be applied. It may be appreciated that the computational complexity of the present method is substantially reduced—especially on the encoder.

It is to be understood that the method steps described herein do not necessarily have to be performed in the order as described. Further, words such as “thereafter”, “then”, “next”, etc. are not intended to limit the order of the steps. These words are simply used to guide the reader through the description of the method steps.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of compressing video content, the method comprising:
receiving an image frame of a video signal having multiple components;
generating an edge-map for the image frame;
generating a bitstream comprising edge-map information
generating a bitstream base layer for each component of the video signal;
generating a first bitstream enhancement layer for each component of the video signal; and
generating successive bitstream enhancement layers for each component of the video signal, wherein as the successive bitstream enhancement layers are generated, the method of compressing video content goes from lossy to lossless.

2. The method of claim 1, wherein the edge-map is generated by locating all edges of an image within the image frame.

3. The method of claim 2, further comprising: outputting edge data information, where the edge data information includes edge pixel values and edge pixel location.

4. The method of claim 3, further comprising:
scanning each row of pixels from the image; and
determining each midpoint for each row of pixels.

5. The method of claim 4, further comprising:
scanning each column of pixels from the image; and
determining each midpoint for each column of pixels.

6. The method of claim 5, wherein each midpoint is a midpoint between two edges, a midpoint between one edge and an image border, or a midpoint between two opposite image borders.

7. The method of claim 6, further comprising:
outputting pixel samples, wherein the pixel samples include midpoint data for each row and midpoint data for each column.

8. The method of claim 7, further comprising:
scanning each row of sampled pixels;
determining whether a distance between previously sampled pixels for each row of sample pixels is greater than a scalability factor; and
determining a midpoint between previously sampled pixels for each row of sample pixels when the distance between previously sampled pixels is greater than the scalability factor.

9. The method of claim 8, further comprising:
scanning each column of sampled pixels;
determining whether a distance between previously sampled pixels for each column of sample pixels is greater than a scalability factor; and
determining a midpoint between previously sampled pixels for each column of sample pixels when the distance between previously sampled pixels is greater than the scalability factor.

10. The method claim 9, further comprising:
determining two nearest pixel samples from a previous image frame; and
determining whether the two nearest pixel samples are within the edges of the image.

11. The method of claim 10, further comprising
setting a value of the predicted current pixel sample equal to a weighted average value of the two nearest pixel samples, when the two nearest pixel samples are within the edges of the image; and
setting a value of the predicted current pixel sample equal to a value of the closest pixel sample within the edges of the image, when the two nearest pixel samples are not within the edges of the image.

12. The method of claim 11, further comprising:
determining two nearest pixel samples from a previous iteration for each current pixel sample; and
determining whether the two nearest pixel samples are within the edges of the image.

13. The method of claim 12, further comprising
setting a value of the predicted current pixel sample equal to a weighted average value of the two nearest pixel samples, when the two nearest pixel samples are within the edges of the image; and
setting a value of the predicted current pixel sample equal to a value of the closest pixel sample within the edges of the image, when the two nearest pixel samples are not within the edges of the image.

14. A wireless device, the wireless device comprising:
means for receiving an image frame of a video signal having multiple components;
means for generating an edge-map for the image frame;
means for generating a bitstream base layer for each component of the video signal;
means for generating a first bitstream enhancement layer for each component of the video signal; and
means for generating successive bitstream enhancement layers for each component of the video signal, wherein as the successive bitstream enhancement layers are generated, compressed video content goes from lossy to lossless.

15. The wireless device of claim 14, wherein the edge-map is generated by locating all edges of an image within the image frame.

16. The wireless device of claim 15, further comprising:
means for scanning each row of pixels from the image; and
means for determining each midpoint for each row of pixels.

17. The wireless device of claim 16, further comprising:
means for scanning each column of pixels from the image; and
means for determining each midpoint for each column of pixels.

18. The wireless device of claim 17, wherein each midpoint is a midpoint between two edges, a midpoint between one edge and an image border, or a midpoint between two opposite image borders.

19. The wireless device of claim 18, further comprising:
means for outputting pixel samples, wherein the pixel samples include midpoint data for each row and midpoint data for each column.

20. The wireless device of claim 19, further comprising:
means for scanning each row of sampled pixels;
means for determining whether a distance between previously sampled pixels for each row of sample pixels is greater than a scalability factor; and
means for determining a midpoint between previously sampled pixels for each row of sample pixels when the distance between previously sampled pixels is greater than the scalability factor.

21. The wireless device of claim 20, further comprising:
means for scanning each column of sampled pixels;
means for determining whether a distance between previously sampled pixels for each column of sample pixels is greater than a scalability factor; and
means for determining a midpoint between previously sampled pixels for each column of sample pixels when the distance between previously sampled pixels is greater than the scalability factor.

22. The wireless device of claim 21, further comprising:
means for determining two nearest pixel samples from a previous image frame; and
means for determining whether the two nearest pixel samples are within the edges of the image.

23. The wireless device of claim 22, further comprising
means for setting a value of the predicted current pixel sample equal to a weighted average value of the two nearest pixel samples, when the two nearest pixel samples are within the edges of the image; and
means for setting a value of the predicted current pixel sample equal to a value of the closest pixel sample within the edges of the image, when the two nearest pixel samples are not within the edges of the image.

24. The wireless device of claim 23, further comprising:
means for determining two nearest pixel samples from a previous iteration for each current pixel sample; and
means for determining whether the two nearest pixel samples are within the edges of the image.

25. The wireless device of claim 24, further comprising
means for setting a value of the current pixel sample equal to an average value of the two nearest pixel samples, when the two nearest pixel samples are within the edges of the image; and
means for setting a value of the current pixel sample equal to a value of the closest pixel sample within the edges of the image, when the two nearest pixel samples are not within the edges of the image.

26. A wireless device, the wireless device comprising:
a processor, wherein the processor is operable to:
receive an image frame of a video signal having multiple components;
generate an edge-map for the image frame;
generate a bitstream base layer for each component of the video signal;
generate a first bitstream enhancement layer for each component of the video signal; and
generate successive bitstream enhancement layers for each component of the video signal, wherein as the successive bitstream enhancement layers are generated, compressed video content goes from lossy to lossless.

27. The wireless device of claim 26, wherein the edge-map is generated by locating all edges of an image within the image frame.

28. The wireless device of claim 27, wherein the processor is further operable to:
scan each row of pixels from the image; and
determine each midpoint for each row of pixels.

29. The wireless device of claim 28, wherein the processor is further operable to:
scan each column of pixels from the image; and
determine each midpoint for each column of pixels.

30. The wireless device of claim 29, wherein each midpoint is a midpoint between two edges, a midpoint between one edge and an image border, or a midpoint between two opposite image borders.

31. The wireless device of claim 30, wherein the processor is further operable to:
output pixel samples, wherein the pixel samples include midpoint data for each row and midpoint data for each column.

32. The wireless device of claim 31, wherein the processor is further operable to:
scan each row of sampled pixels;
determine whether a distance between previously sampled pixels for each row of sample pixels is greater than a scalability factor; and
determine a midpoint between previously sampled pixels for each row of sample pixels when the distance between previously sampled pixels is greater than the scalability factor.

33. The wireless device of claim 32, wherein the processor is further operable to:
scan each column of sampled pixels;
determine whether a distance between previously sampled pixels for each column of sample pixels is greater than a scalability factor; and
determine a midpoint between previously sampled pixels for each column of sample pixels when the distance between previously sampled pixels is greater than the scalability factor.

34. The wireless device of claim 33, wherein the processor is further operable to:
determine two nearest pixel samples from a previous image frame; and
determine whether the two nearest pixel samples are within the edges of the image.

35. The wireless device of claim 34, wherein the processor is further operable to:
set a value of the predicted current pixel sample equal to a weighted average value of the two nearest pixel samples, when the two nearest pixel samples are within the edges of the image; and
set a value of the predicted current pixel sample equal to a value of the closest pixel sample within the edges of the image, when the two nearest pixel samples are not within the edges of the image.

36. The wireless device of claim 35, wherein the processor is further operable to:
determine two nearest pixel samples from a previous iteration for each current pixel sample; and
determine whether the two nearest pixel samples are within the edges of the image.

37. The wireless device of claim 36, wherein the processor is further operable to
set a value of the current pixel sample equal to an average value of the two nearest pixel samples, when the two nearest pixel samples are within the edges of the image; and
set a value of the current pixel sample equal to a value of the closest pixel sample within the edges of the image, when the two nearest pixel samples are not within the edges of the image.

38. A computer program product, comprising:
a computer-readable medium, comprising:
at least one instruction for receiving an image frame of a video signal having multiple components;
at least one instruction for generating an edge-map for the image frame;
at least one instruction for generating a bitstream base layer for each component of the video signal;
at least one instruction for generating a first bitstream enhancement layer for each component of the video signal; and
at least one instruction for generating successive bitstream enhancement layers for each component of the video signal, wherein as the successive bitstream enhancement layers are generated, compressed video content goes from lossy to lossless.

39. The computer program product of claim 38, wherein the edge-map is generated by locating all edges of an image within the image frame.

40. The computer program product of claim 39, wherein the computer-readable medium further comprises:
at least one instruction for scanning each row of pixels from the image; and
at least one instruction for determining each midpoint for each row of pixels.

41. The computer program product of claim 40, wherein the computer-readable medium further comprises:
at least one instruction for scanning each column of pixels from the image; and
at least one instruction for determining each midpoint for each column of pixels.

42. The computer program product of claim 41, wherein each midpoint is a midpoint between two edges, a midpoint between one edge and an image border, or a midpoint between two opposite image borders.

43. The computer program product of claim 42, wherein the computer-readable medium further comprises:
at least one instruction for outputting pixel samples, wherein the pixel samples include midpoint data for each row and midpoint data for each column.

44. The computer program product of claim 43, wherein the computer-readable medium further comprises:
at least one instruction for scanning each row of sampled pixels;
at least one instruction for determining whether a distance between previously sampled pixels for each row of sample pixels is greater than a scalability factor; and
at least one instruction for determining a midpoint between previously sampled pixels for each row of sample pixels when the distance between previously sampled pixels is greater than the scalability factor.

45. The computer program product of claim 44, wherein the computer-readable medium further comprises:
at least one instruction for scanning each column of sampled pixels;
at least one instruction for determining whether a distance between previously sampled pixels for each column of sample pixels is greater than a scalability factor; and
at least one instruction for determining a midpoint between previously sampled pixels for each column of sample pixels when the distance between previously sampled pixels is greater than the scalability factor.

46. The computer program product of claim 45, wherein the computer-readable medium further comprises:
at least one instruction for determining two nearest pixel samples from a previous image frame; and
at least one instruction for determining whether the two nearest pixel samples are within the edges of the image.

47. The computer program product of claim 46, wherein the computer-readable medium further comprises:
at least one instruction for setting a value of the predicted current pixel sample equal to a weighted average value of the two nearest pixel samples, when the two nearest pixel samples are within the edges of the image; and
at least one instruction for setting a value of the predicted current pixel sample equal to a value of the closest pixel sample within the edges of the image, when the two nearest pixel samples are not within the edges of the image.

48. The computer program product of claim 47, wherein the computer-readable medium further comprises:
at least one instruction for determining two nearest pixel samples from a previous iteration for each current pixel sample; and
at least one instruction for determining whether the two nearest pixel samples are within the edges of the image.

49. The computer program product of claim 48, wherein the computer-readable medium further comprises
at least one instruction for setting a value of the current pixel sample equal to an average value of the two nearest pixel samples, when the two nearest pixel samples are within the edges of the image; and
at least one instruction for setting a value of the current pixel sample equal to a value of the closest pixel sample within the edges of the image, when the two nearest pixel samples are not within the edges of the image.
